(19) United States
(12) Patent Application Publication
(10) Pub. No.: US 2009/0283516 A1
(43) Pub. Date: Nov. 19, 2009

(54) Stable high-Q magnetron power supply

(76) Inventors: Clayton R. DeCamillis, Raleigh, NC (US); Lars Haubold, East Lansing, MI (US); Richard C. Hazlehurst, Holly Springs, NC (US); Jerry K. Wessel, St. Charles, IL (US)

Correspondence Address: ROBERT J. LAUF, 998 W. OUTER DRIVE, OAK RIDGE, TN, 37830, US

(21) Appl. No.: 12/381,794

(22) Filed: Mar. 17, 2009

Related U.S. Application Data
(60) Provisional application No. 61/069,856, filed on Mar. 18, 2008.

(51) Int. Cl. H05B 6/70

(52) U.S. Cl. 219/690

(57) ABSTRACT

A microwave power supply includes a magnetron, a waveguide configured to carry microwave power from the magnetron to a selected load, and an adjustable impedance element connected to the waveguide at a location upstream from the magnetron. The power supply may further include provision for varying the filament voltage to the magnetron tube. In the associated method, the adjustable upstream impedance and the adjustable filament voltage may be combined (and may be adjusted iteratively) to achieve high Q output. The load may be an applicator cavity for processing selected materials. The invention is particularly suitable for high Q cavities, such as single mode cavities, where it is desirable to match the output of the microwave source to the characteristics of the cavity for efficient operation. The adjustable upstream impedance element represents an electrical characteristic that may be achieved through various physically adjustable devices such as a movable backwall, a sliding short, a stub tuner, or an adjustable iris.

### CROSS REFERENCE TO RELATED APPLICATION

This application claims the benefit of Provisional Application Ser. No. 61/069,856 entitled, “Stable High-Q Magnetrons Having Controllable Filament Voltage and Backwall Distance” filed by the present inventors on Mar. 18, 2008, the entire disclosure of which is incorporated herein by reference.

### BACKGROUND OF THE INVENTION

1. Field of the Invention

The invention pertains to apparatus and methods for generating microwave power and more particularly to apparatus and methods for providing microwave power from a magnetron source suitable for use with a high-Q applicator cavity.

2. Description of Related Art

Many applications of microwave processing, particularly continuous processing of fiber products and coatings thereon, rely on a single-mode cavity in which microwave power is maintained in a carefully controlled mode pattern, generally with the material to be processed continuously passing through the area of highest power density. The high power density areas are best obtained using high-Q cavities.

High-Q single-mode applications require a stable microwave power source with a narrow output bandwidth to effectively couple microwave power into a processing chamber. Magnetron systems with a broad output bandwidth do a poor job of coupling energy to the chamber, significantly reducing the efficiency of the process. Furthermore, minor variations in the output frequency can result in the loss of coupling and require significant effort to retune the system. This is accompanied by high reflected power that may be detrimental to the magnetron. In other words high Q cavities require special magnetrons with stable and narrow frequency output, which makes these magnetrons costly.

One method for addressing coupling issues is to operate a magnetron source at its optimum performance point while shunting excess power to a dummy load as described in Bulletin #96000—Stable Tuning of High Q Loads [2003, Gerling Applied Power Engineering, Inc.] The drawback of this method is that power dissipated in the dummy load is wasted, so the overall system efficiency suffers. Another practical limitation is that the tuning stub has a limited range of power adjustment. Furthermore, tuning stubs are not effective at decoupling the frequency between the load and the generators.

In the case of multimode applicators such as those used for industrial cooking systems, although the power density within the cavity is inherently less uniform than in a single mode applicator, the process could benefit if the power distribution were more stable with time and more repeatable.

### OBJECTS AND ADVANTAGES

Objects of the present invention include the following: providing a power supply for single mode fiber processing applications; providing a magnetron power supply having improved stability, high Q output, and a broad power range; providing a magnetron power supply that may be used with a single chamber or with multiple chambers to create a tuned or variable process profile; providing a low-cost power source for microwave stimulated plasma applications; providing a magnetron power supply capable of accommodating normal variability in off-the-shelf magnetron tubes; providing a method for controlling the output of a magnetron power supply; and, providing a method whereby voltage and power level in a magnetron may be varied simultaneously. These and other objects and advantages of the invention will become apparent from consideration of the following specification, read in conjunction with the drawings.

### SUMMARY OF THE INVENTION

According to one aspect of the invention, an apparatus for microwave processing comprises: a microwave applicator cavity suitable for exposing a selected material to microwave energy; a microwave power supply including a magnetron; a waveguide configured to carry microwave power from the magnetron to an applicator cavity; and, an adjustable impedance element connected to the waveguide at a location upstream from the magnetron.

According to another aspect of the invention, method for microwave processing comprises the steps of: placing material to be processed into an applicator cavity; introducing microwave energy from a magnetron into a waveguide launcher connected to the cavity; reducing the filament voltage in the magnetron to a point below a stability threshold; and, increasing the filament voltage to a selected operating point above the stability threshold.

According to another aspect of the invention, an apparatus for generating a high Q microwave signal comprises: a microwave power supply including a magnetron; a waveguide configured to carry microwave power from the magnetron to a selected load; and, an adjustable impedance element connected to the waveguide at a location upstream from the magnetron.

According to another aspect of the invention, a method for generating a high Q microwave signal comprises the steps of: introducing microwave power from a magnetron into a waveguide launcher, the launcher further comprising an adjustable impedance element at a location upstream from the magnetron; reducing the filament voltage applied to the magnetron to a selected point below a stability threshold; and, increasing the filament voltage to a selected operating point.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1, identified as PRIOR ART, presents schematically the conventional layout of a microwave heating system including an applicator cavity, a waveguide, and a magnetron disposed at a fixed distance from the backwall of the waveguide.

FIG. 2 illustrates an embodiment of the present invention, in which a magnetron is mounted in a waveguide and the waveguide has a backwall configured to be adjusted relative to the fixed magnetron mount.

FIG. 3 illustrates an alternative embodiment of the present invention in which the waveguide has a fixed backwall and the position of the magnetron is adjustable relative to the fixed backwall.

FIG. 4 illustrates an alternative embodiment of the present invention in which three single-mode cavities are independently adjustable to provide three stages of treatment to a moving fiber product.

### DETAILED DESCRIPTION OF THE INVENTION

The invention is intended to enable precision frequency stability and high-Q output over a broad power output range while using low cost magnetron sources. The inventive power supply is particularly useful for high-Q single mode applications. Using the invention for these applications, Applicants have found that the reflected power can be less than 2-3% of forward power, compared with 15 to 25% for prior commercial magnetron systems.

The invention includes a new magnetron launcher and a novel control system to manipulate the magnetron filament voltage. These two features may be used separately, or, more preferably, they may be used together for further synergistic benefits. In the examples that follow, various aspects of the invention will be presented in detail and the uses and advantages of the invention will become apparent.

In general terms, the invention preferably relies on a standard off-the-shelf magnetron tube as is familiar in the art. A magnetron launcher is provided having an adjustable impedance element upstream from the magnetron, which pulls the magnetron frequency into a stable operating region. (As used herein, “downstream” refers to the direction in which microwave power flows from the magnetron to the load; “upstream” refers to the direction from the magnetron back toward the backwall of the waveguide. The upstream and downstream directions will therefore usually be 180° apart.) There may be one or more stable regions which result in good coupling of the magnetron energy to the waveguide and result in improved stability. Various means may be provided to adjust the upstream impedance, such as varying the back wall distance to optimize tuning and account for variations from one magnetron to another. Further, by adjusting the filament voltage to reduce unneeded electrons in the magnetron head, the output bandwidth may be improved. The ability to control the filament voltage relative to the output power of the magnetron allows the operator to optimize a narrow output bandwidth referred to as a high Q output, over a broad output power range. This may be done at discrete points or in a continuous fashion. The optimum filament voltage may be determined using a manual tuning procedure or the control points may also be automatically determined from a self teaching algorithm. In this invention, the filament voltage may be controlled automatically to attain a high Q operating point based on the operator's selection of output power level. This invention also allows for the automatic startup of the magnetron (preheat) and tuning through a low voltage stability threshold. The low voltage stability threshold cleans up the output spectrum of the magnetron prior to using the normal operating range of the device and is an important aspect of the invention. This low voltage stability threshold is critical to improving the output. (Magnetrons typically require high filament excitation to start oscillation and then a reduction in voltage until the desired output spectrum is achieved.) The stability threshold is a filament voltage at which Q displays a local maximum; it is typically a value less than about 60% of the nominal operating voltage and may be as low as 10% of the nominal value.

The conventional interface used for coupling microwave power to a cavity generally uses a waveguide launcher. It is standard practice to locate the output terminal of the magnetron tube at a fixed distance (typically ¼ guided wavelength) from the backwall of the waveguide. Systems using standard launchers are available from manufacturers such as Gerling Applied Engineering, Inc., (Modesto, Calif. 95358), Richardson Electronics (LaFox, Ill. 60147), Sairem SAS (Neyron, France), Cober-Muegge LLC (Norwalk, Conn. 06854). Through experimentation, Applicants discovered that deviation from standard practice significantly improved the ability to tune the system efficiently. The experimental work is summarized in several examples that follow.

The advantages achieved through this invention are to render ordinary magnetrons capable of powering high Q cavities. The inventive approach yields high spectrum quality, narrow and stable bandwidth of output over a broad range of powers from standard magnetrons. This is achieved through a novel configuration in which an adjustable impedance element is disposed in the waveguide upstream from the magnetron. Applicants speculate that, among other things, the adjustable impedance provides a means of compensating for minor variations that are commonly seen from one magnetron tube to another.

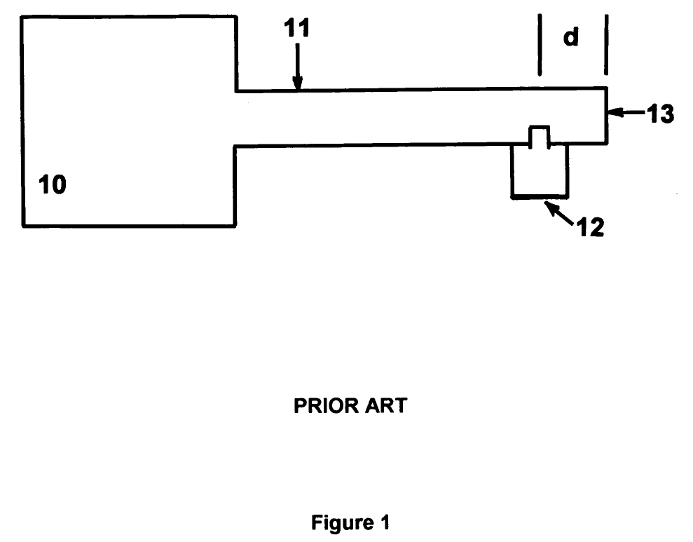

As illustrated schematically in FIG. 1, conventional microwave heating systems traditionally contain an applicator cavity 10, which might be a single mode or multimode applicator cavity, a waveguide 11, and a magnetron 12. The magnetron 12 is typically located at a fixed distance d from the backwall 13 of waveguide 11. The distance d is a function of the operating wavelength based on recommendations developed by the magnetron supplier (see, e.g., H3881 CW Magnetron Data Sheet, Hitachi Electron Devices, Ltd. for an illustration of a fixed waveguide launcher). For simplicity, other commonly used components such as stub tuners, circulators, and couplers are not shown in FIG. 1; these are placed at selected locations in waveguide 11 between the applicator 10 and magnetron 12, i.e., downstream from the magnetron. Stub tuners, for example, are used to match the load impedance of the applicator for optimal performance. Typical conventional waveguide configurations are shown, for example, in Application Bulletin #960006, Stable Tuning of High Q Loads (Gerling Applied Engineering, Inc., Modesto, Calif.).

### Example

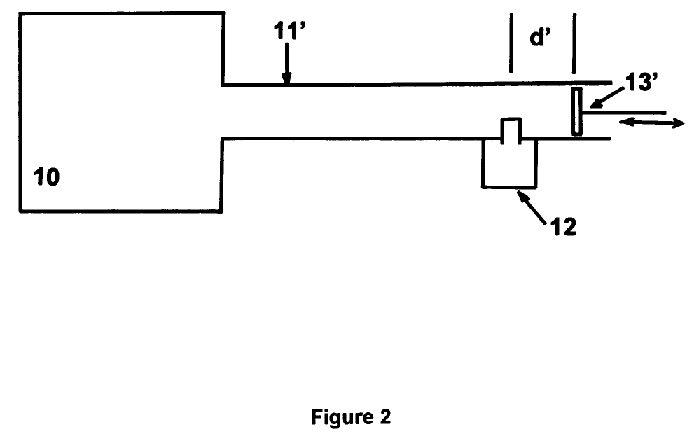

As illustrated schematically in FIG. 2, the inventive system was modified by removing the fixed end 13 of waveguide 11′ upstream of magnetron 12 and replacing it with a sliding short 13′, creating an adjustable spacing d′ between the magnetron 12 and the backwall 13′. Applicants discovered, surprisingly, that this adjustment was extremely effective in “pulling” the magnetron into a stable operating condition.

### Example

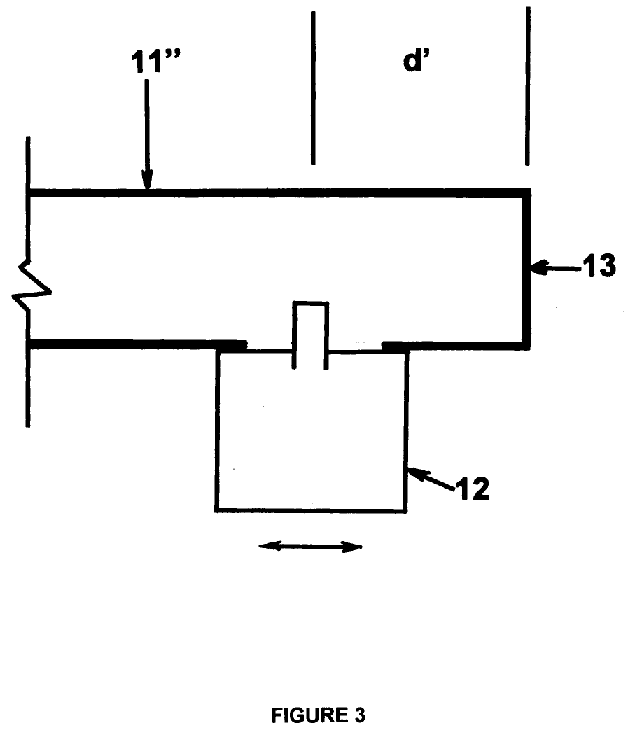

As illustrated schematically in FIG. 3, the same effect as in the previous example may be achieved by using a waveguide 11″ having a fixed backwall 13 and a mounting for magnetron 12 that allows the magnetron to slide forward or back, thereby adjusting the spacing d′.

It will be appreciated that a movable backwall 13′ or a movable mount for magnetron 12 in essence create an adjustable impedance element upstream from the magnetron. Those skilled in the art will recognize that other familiar components such as a stub tuner or an iris may in some cases be placed upstream from the magnetron as an alternate means of creating an adjustable impedance element in that part of the microwave circuit.

### Example

A tunable single cavity was constructed having a nominal inside diameter of 7 in. (17.2 cm) and a length that was adjustable over a nominal range of about 5.2 to 6.1 in. (13.2 to 15.5 cm) by means of movable end plates. A small orifice was provided at each end to allow a fiber to pass axially through the cavity for processing. S11 measurements were obtained using a network analyzer. The cavity was measured both in its empty state and loaded state. In its empty state the cavity exhibits the sharpest reflection over a very narrow bandwidth. Once the cavity is loaded with a fiber for the purpose of processing the fiber, a slightly broader reflection is observed. The broadening of the reflected frequencies depends to some degree on the dielectric constant and the dielectric loss of the load. A microwave generator needed to power such a resonant cavity needs to have good enough spectral purity that its power output over a central frequency will match the Q of the cavity. Applicants found that a conventional generator was not able to meet the necessary spectral response to power the cavity efficiently. However, by modifying the backwall of the waveguide launcher to enable the backwall distance to be adjusted, and using the inventive method of adjusting the filament voltage to remove excess or uncontrolled electron distribution in the tube, this generator was rendered capable of coupling and energizing the high Q resonant cavity. Furthermore, the magnetron was tested over a broad range of output powers to check its frequency stability. The inventive generator was tested from 200 to 1200 W power outputs and it was discovered that that method of pulling the magnetron using backwall adjustment is very effective in stabilizing the spectral output. This was further tested by coupling the generator to the high Q cavity and observing its effectiveness in maintaining resonance over long periods of time.

### Example

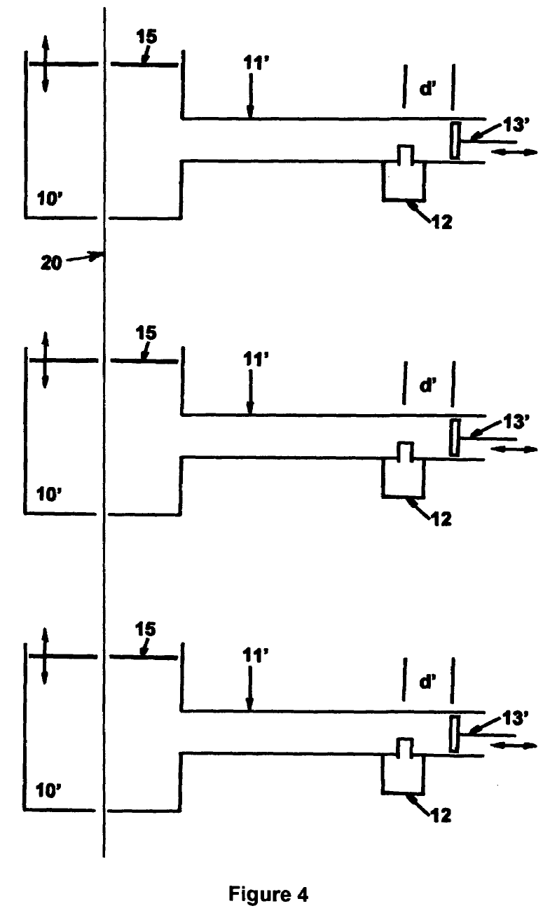

In a fiber processing apparatus, three similar single mode cavities 10′ as described generally in the preceding example were required to subject a moving fiber 20 to three successive stages of treatment, as illustrated schematically in FIG. 4. Each cavity 10′ had a nominal inside diameter of 7 in. (17.2 cm) and a length that was adjustable over a nominal range of about 5.2 to 6.1 in. (13.2 to 15.5 cm) by means of movable end plates 15. Magnetron power supplies with a nominal output of 1200 W at 2.45 GHz were installed on each waveguide 11′ having a flange at the cavity end and a movable backwall 13′ upstream from the magnetron 12.
After adjustments to maximize Q, the dimensions were as shown in the following table. The last line in the table presents the comparable dimensions of a “standard” launcher. Two things are noteworthy in the tabulated dimensions. First, the optimal backwall position was slightly different for each head, possibly reflecting small differences in the three nominally identical magnetrons. Second, in each case the optimal dimensions are quite different from those of a standard launcher.
Dimensions of microwave launchers

| | Flange to front of magnetron | Flange to launcher |
|---|---|---|
| | antenna, in. (cm) | backwall, in. (cm) |
| Head 1 | 6.43 (16.33) | 10.46 (26.57) |
| Head 2 | 6.44 (16.35) | 10.45 (26.54 |
| Head 3 | 6.44 (16.35) | 10.47 (26.59) |
| Standard | 5.6 (14.22) | 6.7 (17.02) |
| launcher | | |

Although the foregoing exemplary system employed three applicator cavities, it will be understood that any number of cavities may be employed in carrying out the invention for a particular processing application. It will also be appreciated that although the invention is of particular benefit for applications that require coupling to a high Q cavity, the inventive method may also provide benefits in multimode applicators, in which the power density is fairly non-uniform. Such applications might include, for instance, industrial cookers in which food products are passing on a conveyor. In such cases, the invention can enhance the stability and repeatability of the cooking process because if the frequency output is stable and well-controlled, whatever microwave mode patterns exist in the applicator will tend to be more stable over time and cooking results will tend to be more reproducible as a consequence.

In addition to the effects of tube-to-tube variations, another source of non-uniform performance involves chaotic processes taking place in the distribution of electrons inside the magnetron tube itself. Applicants have discovered that by adjusting the voltage applied to the filament, non-uniformities can be significantly reduced, leading to high-Q output. Adjusting the filament voltage is particularly effective when used in combination with the adjustable impedance described in the foregoing examples.

### Example

The inventive method of adjusting filament voltage may be described as follows: First the filament is energized to a specified value (say, 180 V) to allow for a nominal warm up time t₁ (typically 30 s to 1 min); this step is accompanied by observable noise in the spectrum. Then the anode voltage energized to remove the electrons from the filament area, after which the filament voltage is decreased to minimal values below a stability threshold (typically 20 V) and held for time t₂ (typically 15 s). Then an increase in the filament voltage back to higher values (e.g., 60 to 100 V) is needed until the filament is appropriately energized. A different and observably higher spectrum quality is now achieved. This process can be repeated until the magnetron spectral output is very clean. It will be understood that the exemplary values of filament voltage, t₁, and t₂ may vary depending on the particular magnetron tube and other system details. For any given system, the skilled artisan can determine appropriate values through routine experimentation.

Second, the cavity dimension and probe coupling are tuned to obtain the desired mode with the minimum reflected power. The backwall of the launcher (upstream from the magnetron itself) can be moved and adjusted to specific distances that effectively pull the magnetron to one of its stability points and to obtain a clean spectrum with maximum forward power and minimum reflected power. Once at a stable zone, the transmission line is then further tuned by re-tuning the cavity to account for frequency shift of tube operating point. Once this is achieved, then the filament voltage can be reduced to further clean up the spectrum, while still maintaining maximum forward power. The low filament voltage is desirable to avoid tube oscillation.

It will be appreciated that the inventive process can be automated through a dynamic closed loop control or through a pre-established look up table that contains the necessary voltage values and backwall distances. This allows the magnetron pulling and the frequency stability and spectral quality to be coupled to a high Q cavity in an easy and repeatable manner while using a relatively inexpensive power supply and magnetron. A further advantage of the present invention is that it allows the operator to readily adjust to changes in system requirements, load, power level, etc.

It will be appreciated that in many applications stability may be enhanced by keeping the magnetron head at a stable (preferably low) temperature during operation and this is achieved through conventional air or water cooling as is known in the art.

It will further be appreciated that once the resonant cavity reaches equilibrium and its wall temperature becomes stable, minor tuning may be needed to maintain it in resonance. For a given application, there is a threshold of reflected power that warrants retuning and the reflected power is preferably maintained below 10 W at all times for effective resonance and energy coupling inside the cavity.

We claim:

1. An apparatus for microwave processing comprising:
a microwave applicator cavity suitable for exposing a selected material to microwave energy;
a microwave power supply including a magnetron;
a waveguide configured to carry microwave power from said magnetron to said applicator cavity; and,
an adjustable impedance element connected to said waveguide at a location upstream from said magnetron.

2. The apparatus of claim 1 wherein said microwave applicator cavity has at least one frequency at which Q is maximized for a given load.

3. The apparatus of claim 1 further including at least one device selected from the group consisting of: circulators, isolators, couplers, and stub tuners, wherein said at least one device is connected to said waveguide at a location downstream from said magnetron.

4. The apparatus of claim 1 wherein said microwave power supply is configured to allow the magnetron filament voltage to be adjusted to selected values above and below a stability threshold.

5. The apparatus of claim 1 wherein said adjustable impedance element includes a device selected from the group consisting of: sliding shorts; movable backwalls, stub tuners, and irises.

6. The apparatus of claim 1 wherein said adjustable impedance element comprises a mounting fixture configured to allow said magnetron to move relative to the upstream end of said waveguide, thereby creating an adjustable impedance upstream from said magnetron.

7. A method for microwave processing comprising the steps of:
placing material to be processed into an applicator cavity;
introducing microwave energy from a magnetron into a waveguide launcher connected to said cavity;
reducing the filament voltage in said magnetron to a point below a stability threshold; and,
increasing said filament voltage to a selected operating point above said stability threshold.

8. The method of claim 7 wherein said microwave applicator cavity has at least one frequency at which Q is maximized for a given load.

9. The method of claim 7 wherein said waveguide launcher comprises an adjustable impedance element connected to said waveguide at a location upstream from said magnetron.

10. The method of claim 7 wherein said stability threshold is a filament voltage at which Q displays a local maximum.

11. The method of claim 7 wherein said stability threshold is a filament voltage less than about 60% of the nominal operating voltage of the magnetron tube.

12. An apparatus for generating a high Q microwave signal comprising:
a microwave power supply including a magnetron;
a waveguide configured to carry microwave power from said magnetron to a selected load; and,
an adjustable impedance element connected to said waveguide at a location upstream from said magnetron.

13. The apparatus of claim 12 wherein said adjustable impedance element includes a device selected from the group consisting of: sliding shorts; movable backwalls, stub tuners, and irises.

14. The apparatus of claim 12 wherein said microwave power supply is configured to allow the magnetron filament voltage to be adjusted to selected values above and below a stability threshold.

15. The apparatus of claim 14 wherein said stability threshold is a filament voltage at which Q displays a local maximum.

16. The apparatus of claim 14 wherein said stability threshold is a filament voltage less than about 60% of the nominal operating voltage of the magnetron tube.

17. A method for generating a high Q microwave signal comprising the steps of:
introducing microwave power from a magnetron into a waveguide launcher, said launcher further comprising an adjustable impedance element at a location upstream from said magnetron;
reducing the filament voltage applied to said magnetron to a selected point below a stability threshold; and,
increasing said filament voltage to a selected operating point.

18. The method of claim 17 wherein said adjustable impedance element includes a device selected from the group consisting of: sliding shorts; movable backwalls, stub tuners, and irises.

19. The method of claim 17 wherein said stability threshold is a filament voltage at which Q displays a local maximum.

20. The method of claim 17 wherein said stability threshold is a filament voltage less than about 60% of the nominal operating voltage of the magnetron tube.
